(19) United States
(12) Patent Application Publication
(10) Pub. No.: US 2006/0143007 A1
(43) Pub. Date: Jun. 29, 2006

(54) User interaction with voice information services

(76) Inventors: V. Eugene Koh, Los Angeles, CA (US); David John Mitby, Mountain View, CA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/263,541

(22) Filed: Oct. 31, 2005

Related U.S. Application Data
(63) Continuation-in-part of application No. 09/621,715, filed on Jul. 24, 2000.
(63) Continuation-in-part of application No. 11/002,829, filed on Dec. 1, 2004.

(51) Int. Cl. G10L 15/06

(52) U.S. Cl. 704/243

(57) ABSTRACT

An iterative process is provided for interacting with a voice information service. Such a service may permit, for example, a user to search one or more databases and may provide one or more search results to the user. Such a service may be suitable, for example, for searching for a desired entity or object within the database(s) using speech as an input and navigational tool. Applications of such a service may include, for instance, speech-enabled searching services such as a directory assistance service or any other service or application involving a search of information. In one example implementation, an automatic speech recognition (ASR) system is provided that performs a speech recognition and database search in an iterative fashion. With each iteration, feedback may be provided to the user presenting potentially relevant results. In one specific ASR system, a user desiring to locate information relating to a particular entity or object provides an utterance to the ASR. Upon receiving the utterance, the ASR determines a recognition set of potentially relevant search results related to the utterance and presents to the user recognition set information in an interface of the ASR. The recognition set information includes, for instance, reference information stored internally at the ASR for a plurality of potentially relevant recognition results. The recognition set information may be used as input to the ASR providing a feedback mechanism. In one example implementation, the recognition set information may be used to determine a restricted grammar for performing a further recognition.

### RELATED APPLICATIONS

This application is a continuation-in-part of U.S. application Ser. No. 09/621,715, entitled “A VOICE AND TELEPHONE KEYPAD BASED DATA ENTRY METHOD FOR INTERACTING WITH VOICE INFORMATION SERVICES,” filed on Jul. 24, 2000, and is a continuation-in-part of U.S. application Ser. No. 11/002,829, entitled “METHOD AND SYSTEM OF GENERATING REFERENCE VARIATIONS FOR DIRECTORY ASSISTANCE DATA,” filed on Dec. 1, 2004, both of which applications are herein incorporated by reference by their entirety.

### BACKGROUND OF THE INVENTION

Computerized speech recognition is quickly becoming ubiquitous as a fundamental component of automated call handling. Automatic speech recognition (“ASR”) systems offer significant cost savings to businesses by reducing the need for live operators or other attendants. However, ASR systems can only deliver these cost savings and other efficiencies if customers desire to use them.

Many users are reluctant to utilize ASR systems due to frequent errors in recognizing spoken words. Also, such systems often provide a cumbersome and unforgiving interface between the user and the speech engine itself, further contributing to their lack of use.

The conventional speech recognition paradigm is based upon a noisy channel model. More particularly, an utterance that is received at the speech engine is treated as an instance of the correctly pronounced word that has been placed through a noisy channel. Sources of noise include, for example, variation in pronunciation, variation in the realization of phones, and acoustic variation due to the channel (microphones, telephone networks, etc.).

The general algorithm for performing speech recognition is based on Bayesian inference in which the best estimate of the spoken utterance is determined according to:

$$\hat{w} = arg {max P}_{w ∈ L} ( w \text{\textbar} O )$$

where ŵ is the estimate of the correct word and P(W|O) is the conditional probability of a particular word given an observation. Upon application of Bayes' rule, this expression can be expressed as:

$$\hat{w} = arg {max P}_{w ∈ L} ( w \text{\textbar} O ) P ( w )$$

wherein P(O|w) is generally easier to calculate than P(w|O).

The possible space of source sentences that may be spoken by a user may be codified in a grammar. A grammar informs the speech engine of the words and patterns of words to listen for. Speech recognizers may also support the Stochastic Language Models (N-Gram) Specification maintained by the World Wide Web Consortium (W3C) which defines syntax for representing N-Gram (Markovian) stochastic grammars within the well-known W3C Speech Interface Framework. Both specifications define ways to set up a speech recognizer to detect spoken input but define the word and patterns of words by different and complementary methods. Some speech recognizers permit cross-references between grammars in the two formats.

Because ASR systems involve interaction with a user, it is necessary for these systems to provide prompts to the user as they interact with the speech engine. Thus, in addition to the underlying speech engine, ASR systems also typically include a dialogue management system that provides an interface between the speech engine itself and the user. The dialogue management system provides prompts and responses to the user as the user interacts with the speech engine. For example, most practical realizations of speech dialogue management systems incorporate the concept of a “nomatch” condition. A nomatch condition is detected if, for example, the confidence value for the returned result falls below a defined threshold. Upon the detection of this condition, the dialogue management system informs the user that the provided utterance was not recognized and prompts the user to try again.

A relatively new area in which ASR systems have been employed is in search applications. In a search context, an ASR system typically serves as an input/output interface for providing search queries to a search engine and receiving search results. Although formal models for performing speech recognition and associated probabilistic models have been the subject of extensive research efforts, the application of speech recognition systems as a fundamental component in the search context raises significant technical challenges that the conventional speech recognition model cannot address.

### SUMMARY OF THE INVENTION

An ideal search engine utilizing a speech interface would, for example, allow a user to interact with the search engine as they would another person, thereby providing spoken utterances typical in everyday human exchange.

One conventional method that has been employed to provide search functionality utilizing speech recognition includes providing a series of prompts to the user wherein at each prompt a discrete element of information is requested. For example, a user may desire to locate information regarding flight information for particular destinations. At a first prompt, the user may be asked to provide the destination city. At a subsequent prompt, the user may be asked for a departing city. In further prompts, the user may be asked for a particular day, and time etc. Using this discrete method, the set of possible inputs for a given prompt have well-defined and known verbal references. That is, the typical references to the entities (e.g., state names) that are to be located are well-defined and well-known across the user base allowing for a high probability of accurate recognition results.

Although this discrete method can provide satisfactory results, it is deficient for a number of reasons. First, the interface is cumbersome and slow for the user. Typically users desiring to locate information would like to directly indicate the entity they are searching for rather than having to navigate through a series of voice prompts. In addition, this type of method reduces the richness of the search interface as the user is required to provide input conforming to the expected input at a particular prompt. In general, it is appreciated that users would like to interact with a speech engine in more intuitive and natural manner in which they provide a spoken utterance relating to a desired search result as they conceptualize the desired search result itself. For example, rather than navigating through a series of prompts and providing a discrete element of information at each, the user would simply like to provide a more natural input such as “flights from New York to San Francisco on Oct. 14^{th} 2005.”

That is, by locating a desired search result rather than constraining the user's input in a discrete series of prompts, the user would be free to provide verbal input indicating any number of keywords related to the entity they desire to locate. The ASR system may recognize these keywords and return the most appropriate search result based on one or more search algorithms. According to one embodiment consistent with the principles of the invention, it would be desirable to provide a speech interface for searching similar to interfaces of non-speech-based systems. For instance, a speech-based interface may be provided that accepts inputs similar to the methods by which users provide input to text-based search engines (e.g., on the World Wide Web).

However, beyond the inherent technical challenges of the speech recognition paradigm (e.g., noisy channel, variations in user pronunciation, etc.), this type of system raises additional technical issues limiting its practical realization. In particular, because the user input is not constrained at a particular prompt, the ASR system has to cope with a potentially infinite set of references that users may make for particular search results. In general, there exists an infinite number of reference variations for any particular entity that a user desires to locate in a search context.

To carry out the speech/search environment in which the user can provide a more intuitive and unconstrained input, an ASR system must in a single transaction, recognize the user utterance and return relevant search results corresponding to the utterance. This situation is quite challenging, as the scope of possible entities that are the subject of a search are virtually unlimited. Furthermore, a vast multitude of reference variations typically exist for particular entities that users wish to search.

In one example using a directory assistance search application, a user may desire to search for a pizza restaurant formally listed as “Sal and Joe's Pizzeria and Restaurant.” Several examples of possible user references to this establishment may include:
Joe's Pizza
Sal and Joe's
Sal and Joe's Restaurant
Sal and Joe's Pizza in Mountain View, etc.

In another example, a user trying to obtain a particular music file or entry may only remember one or only a few words from the title of a song or album. In yet another example, a user (a caller) trying to locate a person via a directory assistance application may only know a last name, or the listing may be listed in the directory under the spouse's name. When the speaker input does not exactly match a defined entry, or otherwise provides limited information, it is appreciated that conventional systems implementing speech recognition have difficulty finding the most appropriate match. Typically, such difficulty generally results in the ASR system returning either a no-match condition or an incorrect match to the user.

Typically, users interacting with a search system are not aware of the particular reference variations to particular entities that are to be searched, which limits the ability of the search engine to return desired results. The reference information is internal to the search engine itself, and is not presented to the user.

This problem is less severe in text-based search systems for a number of reasons. First, by definition text based search systems do not involve the additional complexity of performing speech recognition. For instance, in speech based search applications, the possibility for the search to fail is significant due to the sensitive nature of the speech recognition process itself.

Furthermore, text-based search applications generally include a user interface that automatically provides feedback and alerts the user to information how the search is proceeding in the form of search results themselves that are displayed to the user. If a user finds that a particular text based search query is not producing the intended results, the user can simply adjust the search query by resubmitting a search result. For example, a user may desire to search for a particular entity expecting that entity to be referenced in a particular way. Upon submitting the text query and receiving search results, the user is automatically exposed to some indication of the reference variations for intended search result in the form of the search results.

Principles of the invention perform invention automatic voice information services that may be applied in any voice recognition environment including dictation, ASR, etc. However, the method has particular value to ASR utilized in search environments.

According to one embodiment consistent with the principles of the invention, speech recognition is performed in an iterative fashion in which during each iteration feedback is provided to the user in a graphical or textual format regarding potentially relevant results. According to one embodiment consistent with the principles of the invention, it is appreciated that such an iterative interface is not available in speech-based search applications and there does not exist current methods or systems to effectively provide feedback to a user indicating how a speech-based search is proceeding by representing the potentially-relevant results to the user.

According to one such system consistent with the principles of the invention, a user desiring to locate information relating to a particular entity or object provides an utterance to the ASR system. Upon receiving the utterance, the ASR system determines a recognition set of potentially relevant search results related to the utterance and presents recognition set information to the user in a textual or graphical format. The recognition set information includes reference information stored internally at the ASR system for a plurality of potentially relevant recognition results. This information serves to provide a cue to the user for subsequent input as the iterative process continues. According to one embodiment, the recognition set information is generated from current and/or past state information for the speech engine itself.

The recognition set information serves to improve the recognition accuracy by providing a context and cue for the user to further interact with the ASR system. In particular, by revealing the ASR system's internal representation (i.e., references) of entities related to the user's desired result the user becomes cognizant of reference variations during the iterative process. The user may then provide subsequent utterances based upon the user's knowledge of references to potentially relevant entities upon which the ASR system reveals further exposition information based on the new utterance. The process continues in an iterative fashion until a single recognition result is determined.

The recognition set information may be also used as an input to the speech recognition engine during each iteration, thus establishing a type of feedback for the ASR system itself. For example, according to one embodiment, at each iteration the recognition set information comprising a set of recognition results is utilized by the ASR system to constrain the current grammar used for the next iteration.

According to one aspect consistent with the principles of the invention, a system is provided that accepts an initial voice input signal and providing successive refinements to perform disambiguation among a number of listed outputs. Such results may be, for example, presented verbally (e.g., by a voice generation system), a multimodal output (e.g., a listing presented in an interface of a computer, cell phone, or other system), or other type of system (e.g., GPS system in a car, a heads-up display in a car, a web interface on a PC, etc.).

According to another aspect consistent with principles of the invention, a multimodal environment is provided wherein the user is exposed to potential reference variations in an iterative fashion. In one specific example, the user is presented such reference variation information in a multimodal interface combining speech and text and/or graphics. Because the user is exposed to the language recognition process and its associated information (e.g., reference variation information), the user is permitted to directly participate in the recognition process. Further, because the user is provided information relating to the inner workings of the language recognition process, the user provides more accurate narrowing inputs as a result, significantly enhancing the potential for accurate results to be returned.

According to one aspect consistent with principles of the invention, a method is provided for performing speech recognition comprising acts of a) setting a current grammar as a function of a first recognition set, b) upon receiving an utterance from a user, performing a speech recognition process as a function of the current grammar to determine a second recognition set, and c) generating a user interface as a function of the second recognition set, wherein the act of generating includes an act of presenting, to the user, information regarding the second recognition set. According to one embodiment, the method further comprises an act d) repeating acts a) through c) until the recognition set has a cardinality value of 1.

According to another embodiment, the act of setting a current grammar as a function of a first recognition set comprises an act of constraining the current grammar to only include the elements in the second recognition set. According to another embodiment, the user interface displays, in at least one of a graphical format and a textual format, the elements of the second recognition set. According to another embodiment, the method further comprises an act of generating an initial grammar, the initial grammar corresponding to a totality of possible search results. According to another embodiment, the initial grammar is generated by determining reference variations for entities to be subjected to search. According to another embodiment, the method further comprises an act of using the initial grammar as the current grammar.

According to another embodiment, elements of the second recognition set are determined as a function of a confidence parameter. According to another embodiment, the method further comprises an act of accepting a control input from the user, the control input determining the current grammar to be used to perform the speech recognition process. According to another embodiment, the method further comprises an act of presenting, in the user interface, a plurality of results, the plurality of results being ordered by respective confidence values associated with elements of the second recognition set. According to another embodiment, the confidence parameter is determined using at least one heuristic and indicates a confidence that a recognition result corresponds to the utterance.

According to another aspect consistent with principles of the invention, a method is provided for performing interactive speech recognition, the method comprising the acts of a) receiving an input utterance from a user, b) performing a recognition of the input utterance and generating a current recognition set, c) presenting the current recognition set to the user, and d) determining, based on the current recognition set, a restricted grammar to be used in a subsequent recognition of a further utterance. According to one embodiment, acts a), b), c), and d) are performed iteratively until a single result is found. According to another embodiment, the act d) of determining a restricted grammar includes an act of determining the grammar using a plurality of elements of the current recognition set.

According to another embodiment, the act c) further comprises an act of presenting, in a user interface displayed to the user, the current recognition set. According to another embodiment, the method further comprises an act of permitting a selection by the user among elements of current recognition set.

According to another embodiment, the act c) further comprises an act of determining a categorization of at least one of the current recognition set, and presenting the categorization to the user. According to another embodiment, the categorization is selectable by the user, and wherein the method includes an act of accepting a selection of the category by the user. According to another embodiment, the act of determining a restricted grammar further comprises an act of weighting the restricted grammar using at least one result of a previously-performed speech recognition. According to another embodiment, the act a) of receiving an input utterance from the user further comprises an act of receiving a single-word utterance.

According to another aspect consistent with principles of the invention, a method is provided for performing interactive speech recognition, the method comprising the acts of a) receiving an input utterance from a user, b) performing a recognition of the input utterance and generating a current recognition set, and c) displaying a presentation set to the user, the presentation set being determined as a function of the current recognition set and at least one previously-determined recognition set. According to one embodiment, the acts a), b), and c) are performed iteratively until a single result is found. According to another embodiment, the act c) further comprises an act of displaying, in a user interface displayed to the user, the current recognition set. According to another embodiment, the method further comprises an act of permitting a selection by the user among elements of the current recognition set.

According to one embodiment, the act c) further comprises an act of determining a categorization of at least one of the current recognition set, and presenting the categorization to the user. According to another embodiment, the categorization is selectable by the user, and wherein the method includes an act of accepting a selection of the category by the user. According to another embodiment, the act c) further comprises an act of determining the presentation set as an intersection of the current recognition set and the at least one previously-determined recognition set. According to another embodiment, the act a) of receiving an input utterance from the user further comprises an act of receiving a single-word utterance.

According to another aspect consistent with principles of the invention, a system is provided for performing speech recognition, comprising a grammar determined based on representations of entities subject to a search, a speech recognition engine that is adapted to accept an utterance by a user to determine state information indicating a current result of a search, and an interface adapted to present to the user the determined state information.

According to one embodiment, the speech recognition engine is adapted to determine one or more reference variations, and wherein the interface is adapted to indicate to the user information associated with the one or more reference variations. According to another embodiment, the speech recognition engine is adapted to perform at least two recognition steps, wherein results associated with one of the at least two recognition steps is based at least in part on state information determined at the other recognition step. According to another embodiment, the speech recognition engine is adapted to store the state information for one or more previous recognition steps.

According to another embodiment, the state information includes a current recognition set and one or more previously-determined recognition sets, and wherein the interface is adapted to determine a presentation set as a function of the recognition set and at least one previously-determined recognition set. According to another embodiment, the speech recognition engine is adapted to perform a further utterance by the user using a grammar based on the state information indicating the current result of the search. According to another embodiment, the system further comprises a module adapted to determine the grammar based on the state information indicating the current result of the search.

According to another embodiment, the state information includes one or more reference variations determined from the utterance. According to another embodiment, the interface is adapted to present to the user the one or more reference variations determined from the utterance. According to another embodiment, the grammar is an initial grammar determined based on a totality of search results that may be obtained by searching the representations of entities. According to another embodiment, the initial grammar includes reference variations for one or more of the entities.

According to another embodiment, the speech recognition engine is adapted to determine a respective confidence parameter associated with each of a plurality of possible results, and wherein the interface is adapted to present to the user a presentation set of results based on the determined confidence parameter. According to another embodiment, the interface is adapted to display to the user the plurality of possible results based on the respective confidence parameter. According to another embodiment, the interface is adapted to display the plurality of possible results to the user in an order determined based on the respective confidence parameter. According to another embodiment, the interface is adapted to filter the plurality of possible results based on the respective confidence parameter and wherein the interface is adapted to present the filtered results to the user.

Further features and advantages consistent with principles of the invention, as well as the structure and operation of various embodiments consistent with principles of the invention, are described in detail below with reference to the accompanying drawings. In the drawings, like reference numerals indicate like or functionally similar elements. Additionally, the left-most one or two digits of a reference numeral identifies the drawing in which the reference numeral first appears. One aspect relates to a method for performing speech recognition of voice signals provided by a user.

### BRIEF DESCRIPTION OF DRAWINGS

In the drawings:

FIG. 1 shows a system capable of performing a speech recognition system according to one embodiment of the present invention;

FIG. 2 shows a conceptual model of a speech recognition system in accordance with one embodiment of the present invention;

FIG. 3A shows a conceptual model of a speech recognition process according to one embodiment of the present invention;

FIG. 3B shows another conceptual model of a speech recognition process according to one embodiment of the present invention;

FIG. 4 shows another conceptual model of a speech recognition process according to one embodiment of the present invention;

FIG. 5 shows an example system architecture according to one embodiment of the present invention;

FIG. 6A shows an example process for performing speech recognition according to one embodiment of the present invention;

FIG. 6B shows another example process for performing speech recognition according to one embodiment of the present invention;

FIG. 7 shows another example system architecture according to one embodiment of the present invention; and

FIG. 8 shows one example system implementation according to one embodiment of the present invention.

### DETAILED DESCRIPTION

The accompanying drawings are not intended to be drawn to scale. In the drawings, each identical or nearly identical component that is illustrated in various figures is represented by a like numeral. For purposes of clarity, not every component may be labeled in every drawing.

One embodiment consistent with the principles of the invention provides speech recognition that improves recognition accuracy and the overall user experience by involving the user in a collaborative process for disambiguating possible recognition results. Aspects consistent with principles of the invention may be applied in any context, but has particular application to the employment of speech recognition systems in a search capacity. For instance, various aspects consistent with principles of the invention may be used to retrieve information relating to particular entities in the world that may be referenced in a variety of ways.

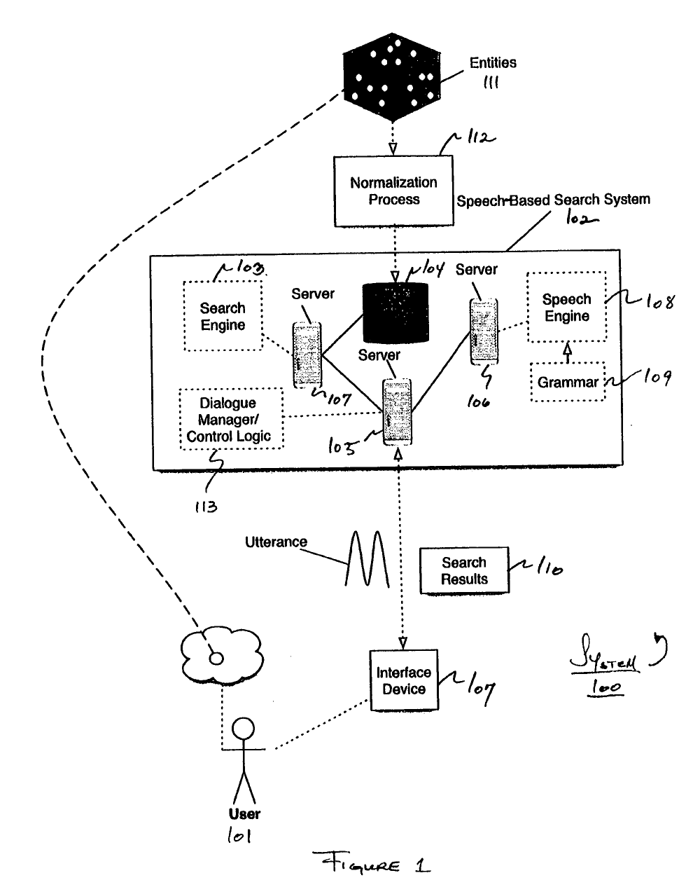

FIG. 1 shows an example ASR system 100 suitable for performing speech-enabled search functions according to one embodiment consistent with principles of the invention. The architecture shown in FIG. 1 is merely shown by way of example only and is not intended to be limiting. It should be understood by those skilled in the art that the architecture to accomplish the functions described herein may be achieved in a multitude of ways.

As shown in FIG. 1, a user 101 has in mind a particular entity for which information is desired. Desired information may include any information relating to the entity, such as an address, phone number, detailed description thereof, etc. User 101 generates a spoken utterance referring to the desired entity, which is provided to speech-based search system 102.

Speech-based search system 102 must determine the proper entity to which the user has referred and provide desired information relating to that entity back to the user. However, the speech-based search system 102 includes a speech-based search engine 103 that uses a predefined internal reference or representation of entities in the form of grammars (e.g., grammar 109) and information stored in a database (e.g., database 104). Thus, to perform effectively, speech-based search system 102 must map accurately the utterance provided by user 101 to the correct reference to the entity in its own internal representation.

Unlike a conventional search engine, speech-based search system 102 provides functionality to allow a user to retrieve information in database using a speech interface. In general, speech-based search engine 102 receives as input a spoken utterance and returns search results to a user either as automatically generated speech, text/graphics or some combination thereof. According to one embodiment, speech-based search system 102 includes a database 104, speech server 105, a speech processing server 106, and search server 107.

As discussed, database 104 stores information relating to entities (e.g., entities 111) that users desire to search. Users may desire to perform searches to retrieve information relating to any type of entities in the world. For example, in a directory assistance context, entities may be businesses for which a user desires to locate information or are otherwise to be the subject of a search. However, in general, entities may be any type of object or thing about which a user desires to retrieve information.

Entities 111 are represented in some manner within database 104. In one embodiment, reference information may be generated for the various entities which are stored in the database. This reference information generation process may be accomplished, for example, using a normalization process 112. Normalization process 112 relates the representation of an entity in the database with the grammar utilized by the speech engine. Ideally, this reference information should correlate to typical references users use for the entities.

According to one embodiment consistent with principles of the invention, the nature of the data stored in search engine may be highly correlated to the grammar that speech engine 103 utilizes to perform speech recognition. This allows recognition results generated by speech server 106 to provide meaningful and accurate recognition results by search engine 103.

Speech server 106 provides an interface for receiving spoken utterances from a user at an interface device 107. Speech server 105 may execute a process for conducting a call flow and may include some process for automatic generation of responses to search queries provided by user 101. To this end, speech server 105 may include a dialogue manager and/or control logic 113 to control the speech recognition dialogue and process. Server 106 includes a speech engine process 108 and performs speech recognition upon utterances received at speech server 106, based on a grammar 109.

Results of the speech recognition process may then be utilized by search engine 103 executing on search server 107 to generate further information regarding the search results. For example, to continue with the directory assistance example discussed above, a user may provide an utterance relating to a particular business they desire to learn information about (e.g., the telephone number, location, etc.). This utterance is received by speech processing server 106 via speech server 105 and speech recognition performed on the utterance to generate one or more recognition results.

The one or more recognition results are then provided to search engine server 107, which performs a search of the one or more recognition results to generate search results 110. Search results 110 are then returned to speech server 105, which provides information regarding the recognition results to user 101 either in the form of automated speech or as text/graphics or some combination thereof.

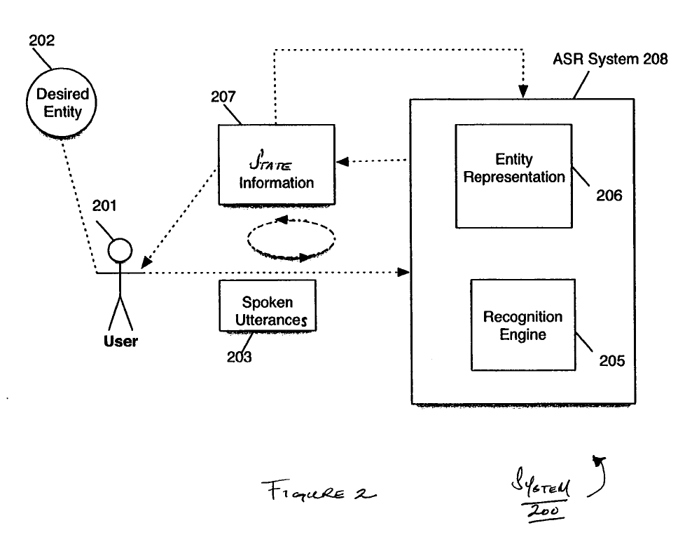

FIG. 2 is a block diagram depicting an operation of speech recognition system 200 for interacting with voice information services according to one embodiment consistent with principles of the invention. User 201 has in mind a particular entity 202 for which search information is desired. An ASR system 208 includes a recognition engine 205 that recognizes search queries provided verbally by user 201 and generates relevant search results based upon some combination of speech recognition and search processes. In general, user 201 is not cognizant of the peculiarities of entity representation, which may be highly subjective and unique to ASR system 208.

Recognition engine 205 symbolizes the functionality to be performed in a speech-based search context of performing speech recognition on submitted utterances and generating relevant search results related to the provided utterance. In addition, as shown in FIG. 2, ASR system 208 includes some form of representation 206 of entities that may be the subject of a search. The scope and content of entity representation 206 is internal to ASR system 208 and is not generally known to user 201. Entity representation 206 may include, for example, particular grammars that are utilized by speech engine and/or databases that are utilized in performing search on queries received at ASR system 208 or any combination thereof.

Upon receiving a spoken utterance 203 relating to desired entity 202 of user 201, ASR system 208 performs speech recognition on the utterance and may also perform some search processes to locate a relevant search result. ASR system 208 then provides state information 207 to the user in a textual or graphical format or some combination thereof. It should be appreciated that, according to one embodiment, the input to ASR system 208 is speech while the output state information 207 may include text and or graphics and may also include speech.

Methods for integrating speech input to ASR system 208 along with text/graphics output are described further below. According to one embodiment, for example, this functionality is achieved utilizing multimodal environments that have become established in the cellular telephone context. For example, typically cellular telephones provide for voice transmission utilizing known modulation and access schemes (e.g., code division multiple access (CDMA) techniques) and also allow for data connectivity (e.g., the Evolution Data Only (EVDO) protocol, etc.). However, it should be appreciated that various aspects consistent with principles of the may be implemented in other types of systems (e.g., in a personal computer (PC) or other type of general-purpose computer system).

Further, it should be appreciated that various aspects of embodiments consistent with the principles of the invention may involve the use of a voice channel, data channel, or both for communicating information to and from the ASR system. In one specific example in a multimodal environment in a cellular telephone context, separate voice and data channels are used. However, in another example, a data channel may be used exclusively to transfer both voice and data. In yet another example, a voice-only channel may be used, and the voice signal may be interlaced with the data using any method, or may be transmitted via a separate band or channel. It should be appreciated that any single data transmission method or combination of transmission methods may be used, and the invention is not limited to any particular transmission method.

In general, state information 207 includes information that indicates the state of ASR system 208 with respect to the user's search request. In general, as is described in detail below, according to one embodiment consistent with principles of the invention, user 207 interacts with ASR system 208 over a series of iterations rather than in a single transaction. In this example, a single search request may be described as a session during which user 207 and ASR system 208 respectively provide information to one another through which the accuracy and efficiency of user's interaction with the voice information services provided by ASR system 208 is improved.

State information 207 may indicate to the user a current state that exists on the ASR system 208 with respect to the user's interaction with system 208. For example, as is described in detail below, a user's interaction with system 208 occurs in an iterative fashion wherein at each step of the iteration, information is provided back to the user as state information 207 that indicates recognition set information and/or state information regarding system 208 itself.

According to one example, state information 207 may include recognition set information (not shown in FIG. 2). Recognition set information may include, for example, any information that indicates a set of potentially relevant results for the user's search request. By providing recognition set information to the user during interaction with ASR system 208, it can be appreciated that the user is exposed to information regarding the internal representation of entities at ASR system 208. For example, according to one embodiment consistent with principles of the invention, recognition set information includes a plurality of possible references to potentially relevant search results related to utterance 203. However, recognition set information may include other information such as category information or other derived information relating to entities that are the subject of a search.

By exposing user 201 to internal entity representation 206, recognition set information provides “cues” to user 201 for providing subsequent spoken utterances 203 in locating relevant search results for desired entity 202. These “cues” improve the recognition accuracy and the location of the desired entity 201 by alerting user 201 to information regarding how the search is proceeding and how they might adapt subsequent utterances to generated search results related to desired entity 202.

Methods for generating recognition set information 207 are described in more detail below. In general, however, reference set information may include information relating to references for entities encoded in grammars used by ASR system 208. In general, it should be recognized that recognition set information provides some feedback to the user regarding potentially relevant search results and how these search results are represented internally at ASR system 208.

As will be described below, the recognition set information may be further processed or formatted for presentation to the user. Such formatted and/or processed information is referred to herein as presentation set information.

According to one embodiment consistent with principles of the invention, user 201 may view and navigate the recognition set information to provide additional input to ASR system 208 in the form of a series of spoken utterances 203, upon which ASR system 208 generates new recognition set information. The process outlined continues in an iterative fashion until a single search result has been determined by ASR system 208. The process, according to one example implementation, may involve an arbitrary number of iterations involving any number of spoken utterances and/or any other input (e.g., keystrokes, cursor input, etc.) used to narrow the search results presented to the user. Such a process is different than conventional speech-based search methods that are limited to a predefined number of speech inputs (e.g., according to some predefined menu structure prompting for discrete inputs), and as a result, not conducive to a variety of searching applications involving different types of data.

In addition, according to one embodiment, recognition set information generated at a particular iteration may also be provided as feedback to ASR system 208 for subsequent iterative steps. For example, according to one embodiment as described below, recognition set information is utilized to constrain a grammar utilized at ASR system 208 for speech recognition performed on subsequent spoken utterances 203.

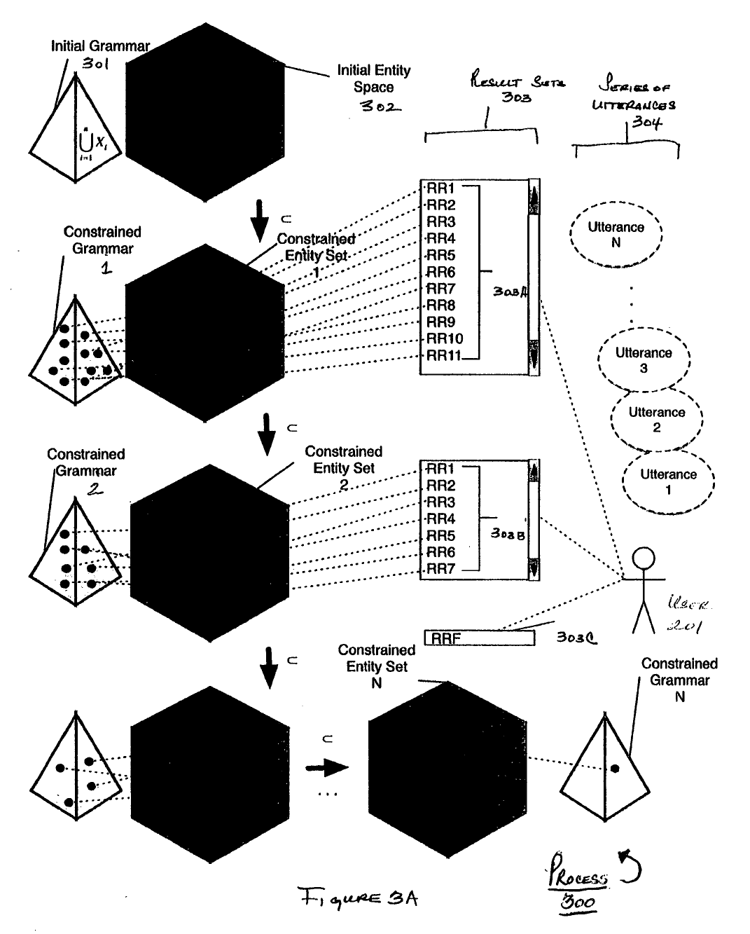

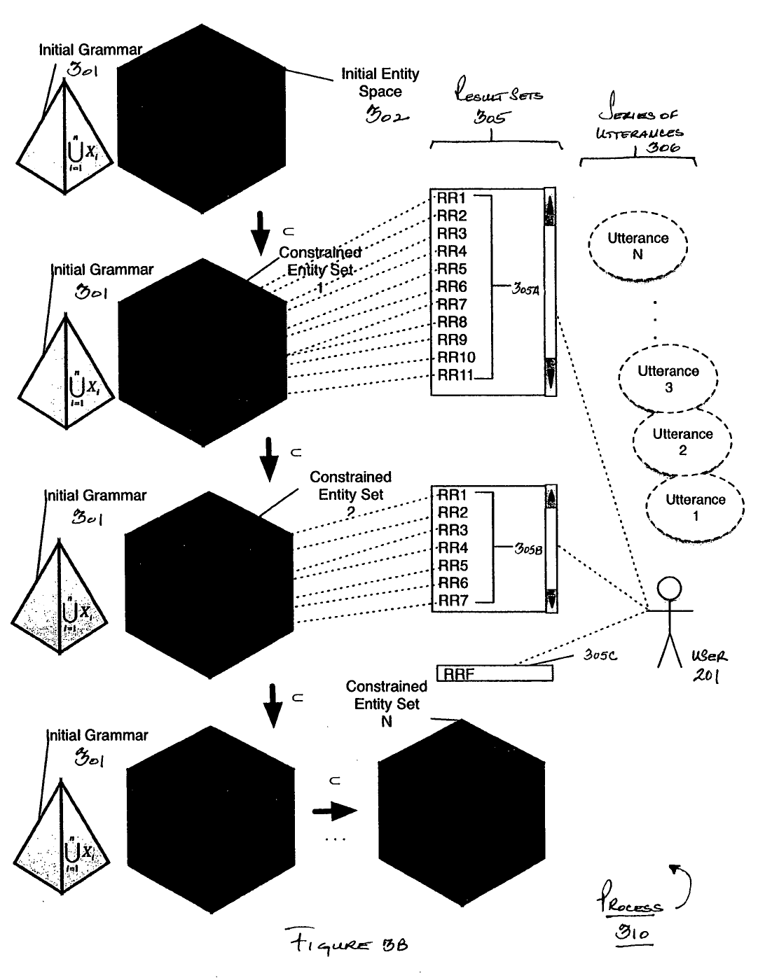

FIG. 3A shows an example of a speech recognition process 300 according to one embodiment consistent with principles of the invention. Such a process may be performed, for example, by an ASR system (e.g., ASR system 208 discussed above with reference to FIG. 2). As discussed, one aspect relates to a speech recognition process involving a search of one or more desired entities. Such entities may reside in an initial entity space 302. This entity space may include, for example, one or more databases (e.g., a directory listing database) to be searched using one or more speech inputs. One or more parameters associated with entities of the initial entity space 302 may be used to define an initial grammar 301 used to perform a recognition of a speech input.

Grammars are well-known in the speech recognition area and are used to express a set of valid expressions to be recognized by an interpreter of a speech engine (e.g., a VoiceXML interpreter). Grammars may take one or more forms, and may be expressed in one or more of these forms. For instance, a grammar may be expressed in the Nuance Grammar Specification Language (GSL) provided by Nuance Communications, Menlo Park, Calif. Also, a grammar may be expressed according to the Speech Recognition Grammar Specification (SRGS) published by the W3C. It should be appreciated that any grammar form may be used, and embodiments consistent with principles of the invention are not limited to any particular grammar form.

According to one embodiment, initial grammar 301 may be determined using elements of the initial entity space 301. Such elements may include, for example, words, numbers, and/or other elements associated with one or more database entries. Further, initial grammar 301 may include any variations of the elements that might be used to improve speech recognition. For instance, synonyms related to the elements may be included in initial grammar 301.

Initial grammar 301 may then be used by the ASR system (e.g., ASR system 208) to perform a first speech recognition step. For instance, user 201 speaks a first utterance (utterance 1) which is then recognized by a speech engine (e.g., of ASR system 208) against initial grammar 301. Based on the recognition, a constrained entity set may be determined from the initial entity space 302 that includes potential matches to the recognized speech input(s). One or more result sets 303 (e.g., set 303A, 303B, etc.) relating to the recognition may then be displayed to user 201 in an interface of the ASR system, the results (e.g., result set 303A) representing a constrained entity set (e.g., constrained entity set 1) of entities from initial entity space 302.

According to one embodiment, a constrained grammar (e.g., constrained grammar 1) may then be determined based on the constrained entity set, and used to perform a subsequent recognition of a further speech input. In one example, user 201 provides one or more further utterances (e.g., utterances 2, 3, . . . N) to further reduce the set of results. Such result sets 303A-C may be presented to user 201 within an interface, prompting user 201 to provide further inputs to further constrain the set of results displayed.

In one embodiment, user 201 iteratively provides speech inputs in the form of a series of utterances 304 until a single result (e.g., result 303C) is located within initial entity space 302. At each step, a constrained grammar may be determined (e.g., by ASR system 208 or other associated system(s)) which is then used to perform a subsequent recognition step, which in turn further constrains the entity set.

FIG. 3B shows an alternative embodiment of a speech recognition process 310 according to one embodiment consistent with principles of the invention. As discussed above with reference to FIG. 3A, one aspect relates to a speech recognition process involving a search of one or more desired entities that reside in an initial entity space 302. Similar to the process discussed above with reference to FIG. 3A, one or more parameters associated with entities of the initial entity space 302 may be used to define an initial grammar 301 used to perform a recognition of a speech input. Also, such a process 310 may be performed by an ASR system 208 as discussed above with reference to FIG. 2.

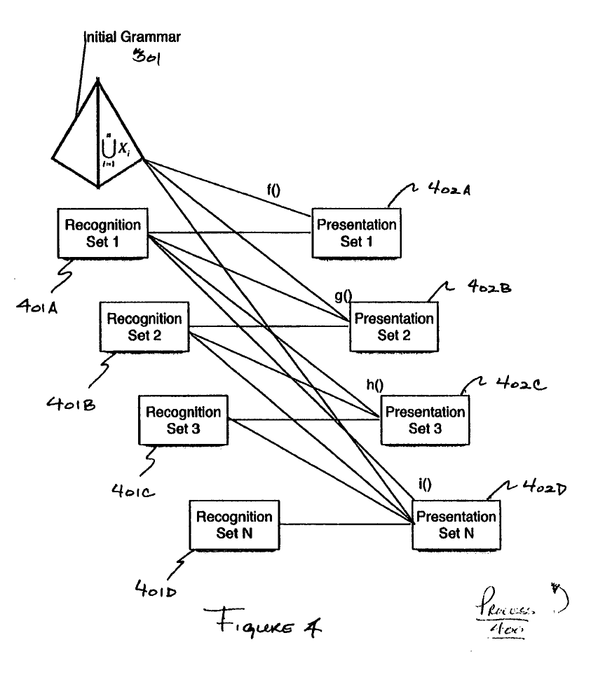

Initial grammar 301 may then be used to perform a first speech recognition step. For instance, user 201 speaks a first utterance (utterance 1) which is then recognized by a speech engine (e.g., of ASR system 208) against initial grammar 301. Rather than constraining the grammar at each step of the iteration as shown in FIG. 3A (described above), the initial grammar is retained for each iteration. However, according to this embodiment, state information is retained at each iteration step. The state information my include a history of recognition sets for each past iteration. However, rather than provide a constrained grammar at each level of the search based on results obtained from a previous recognition step, the system may store a state of the recognition at each step of the process and the system may use initial grammar 301 to perform recognitions at each step. Results sets displayed to the user may be determined, for example, by some function (e.g., as discussed further below with reference to FIG. 4) based on the state of the recognition at each step and any previous steps. In a similar manner as discussed above with reference to FIG. 3A, one or more result sets 305 (e.g., set 305A, 305B, etc.) relating to the recognition may then be displayed to user 201 in an interface, the results (e.g., result set 305A) representing a constrained entity set (e.g., constrained entity set 1) of entities from initial entity space 302.

According to one embodiment, the user may provide a series of utterances (e.g., item 306) to iteratively narrow the result sets (e.g., item 305) displayed to the user. As discussed, the result sets (e.g., sets 305) displayed at each level may be determined as a function of the current recognition set as well as the result(s) of any previously-determined recognition set(s). In one example, user 201 provides one or more further utterances (e.g., utterances 2, 3, . . . N) to further reduce the set of results. Such result sets 305A-C may be presented to user 201 within an interface, prompting user 201 to provide further inputs to further constrain the set of results displayed.

In one embodiment, user 201 iteratively provides speech inputs in the form of a series of utterances 306 until a single result (e.g., result 305C) is located within initial entity space 302. At each step, the displayed result set may be determined as a function of a current recognition and/or search as well as previous recognitions and/or search results, which in turn further constrains the entity set.

FIG. 4 shows another speech recognition process 400 according to one embodiment consistent with principles of the invention. Process 400 relates to process 310 discussed above with respect to FIG. 3B. Similar to process 310, a user 201 is attempting to locate one or more desired entities from an initial entity space 302. However, rather than provide a constrained grammar at each level of the search based on results obtained from a previous recognition step, the system (e.g., ASR system 208) may store a state of the recognition at each step of the process and the system may use the initial grammar (e.g., grammar 301) to perform recognitions at each step.

As shown in FIG. 4, an initial grammar 301 is used to recognize one or more speech inputs provided by user 201. Initial grammar 301 may be determined in the same manner as discussed above with respect to FIGS. 3A-B. Process 400 includes processing multiple iterations of speech inputs which produce one or more recognition sets (e.g., sets 401A-401D). Each of the recognition sets corresponds to a respective presentation set (e.g., presentation sets 402A-402D) of information presented to user 201.

Based upon a recognition of a speech input, a recognition set is determined at each iterative level (for example, by ASR system 208). Also, at each level a current presentation set is determined as a function of the current recognition set and any past recognition sets as matched against the initial grammar. For instance, in determining presentation set 2 (item 402B), the function go may be determined as the intersection of recognition sets 1 and 2. Recognition sets 1 and 2 are produced by performing respective recognitions of sets of one or more utterances by user 201 as matched against initial grammar 301. These recognition sets are stored, for example, in a memory of a speech recognition engine of an ASR system (e.g., system 208).

In one example, user 201 may speak the word “pizza” which is matched by a speech recognition engine against initial grammar 301, producing a recognition set (e.g., recognition set 1 (item 401A)). The recognition set may be used to perform a search of a database to determine a presentation set (e.g., presentation set 1 (item 402A)) of results to be displayed to user 201. User 201 may then provide a further speech input (e.g., the term “Mario's” from the displayed results) to narrow the results, and this further speech input is processed by the speech recognition engine against the initial grammar 301 to determine a further recognition set (recognition set 2 (item 401B)). The intersection of the recognition sets 1 and 2 may be then determined and presented to the user.

More particularly, in this example, an input of “pizza” may be recognized by the speech recognition engine as “pizza,” “pete's,” etc. using initial grammar 301. The user is then presented visually with the results “Joe's Pizza,” “Pizzeria Boston,” “Mario's Pizza,” “Pete's Coffee.” The user then says “Mario's” which is then recognized as “mario's,” “mary's,” etc. using initial grammar 301. Results returned from this refinement search include the result “Mario's Pizza,” which intersects with the result “Mario's Pizza” which resulted from the first search. Thus, the resulting entry “Mario's Pizza” is presented to the user in the interface.

The user may, if presented multiple results, continue to provide additional speech inputs to further narrow the results. According to one embodiment, process 400 continues until a single result is found. Further, the user may be permitted to select a particular result displayed in a display (e.g., by uttering a command that selects a particular entry, by entering a DTMF input selecting a particular entry, etc.).

Aspects of embodiments consistent with principles of the invention may be implemented, for example, in any type of system, including, but not limited to, an ASR system. Below is a description of an example system architecture in which the conceptual models discussed above may be implemented.

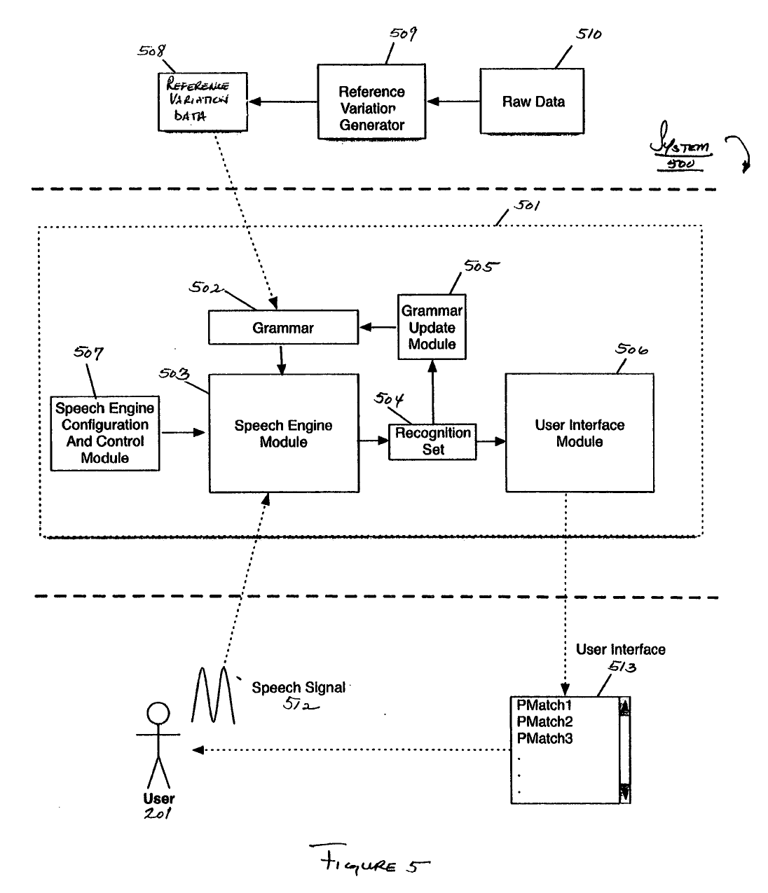

FIG. 5 is a block diagram of a system 500 for providing speech recognition according to one embodiment consistent with principles of the invention. Although system 500 is discussed in relation to a speech recognition system for retrieving directory listings, it should be appreciated that various aspects may be applied in other search contexts involving speech recognition.

In contrast with conventional speech recognition systems, which typically perform a speech recognition process in a single transaction, a speech recognition function may be performed via an iterative process, which may include several steps. The nature of this iterative process may be accomplished, for example, via elements 502, 507, 506 and 505, and will become evident as system 500 is further described. It should be appreciated that one embodiment includes a system 501 that performs an iterative speech recognition process using a series of speech recognition steps. In one embodiment, the system includes a multimodal interface capable of receiving speech input from a user and generating text/graphics as output back to the user inviting further input.

Referring to FIG. 5, raw data 510 is received by reference variation generator 509. Raw data 510 may include, for example, directory assistance listing information. Based upon the raw data 510, reference variation generator 509 may produce reference variation data 508. Reference variation data 508 is used to generate grammar 502, which is utilized by speech engine module 503 to perform one or more speech recognition steps.

Reference variation generator 509 generates possible synonyms for various elements in raw data 510. For example, using the above example, raw data 510 may include the listing “Joe's Bar, Grill and Tavern.” Upon receiving raw data 510, reference variation generator 509 may produce the following synonyms:
“Joe's Bar”
“Joe's”
“Joe's on Main”
etc.

Generally, synonyms may be generated according to how a user actually refers to such entries, thus improving the accuracy of relating a match to a particular speech input. According to one embodiment, synonym information may be generated from raw data as discussed with more particularity in U.S. patent application Ser. No. 11/002,829, entitled “METHOD AND SYSTEM OF GENERATING REFERENCE VARIATIONS FOR DIRECTORY ASSISTANCE DATA,” filed Dec. 1, 2004.

Reference variation data 508 may be converted to a grammar representation and made available to speech engine module 503. For instance, a grammar 502 (such as a Context-Free Grammar (CFG)) may be determined in one or more forms and used for performing a recognition. The generated grammar 502 provides an initial grammar for a speech recognition process, which can be dynamically updated during a speech recognition process. The notion of an initial grammar and dynamic generation of subsequent grammars are discussed above with respect to FIG. 3A.

Upon preparation of initial grammar 502, a speech recognition process may be performed. User 201 generates a speech signal 512, which may be in the form of a spoken utterance. Speech signal 512 is received by speech engine module 503. Speech engine module 503 may be any software and/or hardware used to perform speech recognition.

System 500 includes a speech engine configuration and control module 207 that performs configuration and control of speech engine module 503 during a speech recognition session.

Speech engine module 503 may determine one or more results (e.g., recognition set 504) of a speech recognition to, optionally, a search engine to provide potential matches between entries of a database and the recognized speech signal. Such matches may be presented to the user by a user interface module 506.

A user interface 513 may present the results of the search to user 201 in one or more forms, including, a speech-generated list of results, a text-based list, or any other format. For instance, the list may be an n-best list, ordered based on a confidence level determination made by a speech recognition engine (e.g., module 503). However, it should be appreciated that any method may be used to determine the order and presentation of results. In one embodiment, business rules may be implemented that determine how the information is presented to the user in the interface. In a simple example, a particular database result (e.g., a business listing) may be given precedence within the display based on one or more parameters, either inherent within data associated with the result, and/or determined by one or more functions. For instance, in an example using a business listing search, businesses located closer to the caller (or system, requested city, etc.) and their listings may be preferred over more distant listings, and thus result listings may be shown to the user based on a proximity function. Other applications using other business rules may be used to determine an appropriate display of results.

User 201 reviews the list of results and provides a successive speech input to further narrow the results. The successive speech input is processed by speech engine module 503 that provides a further output that can be used to limit the results provided to the user by user interface module 506.

According to one embodiment, speech engine module 503 may use an initial grammar which is used by speech engine module 503 to match against a user input to provide a recognition result that represents the detected input.

In one implementation, speech engine module 503 accepts, as an input, state information generated from a previous recognition step. Such state information may include, for example, results of a previous search (e.g., a constrained entity set) which may be used to define a limited grammar as discussed above with respect to FIG. 3A. This limited grammar may be then used to perform a successive voice recognition step.

According to another embodiment, speech engine module 503 may determine a reduced recognition set based upon previous states of the recognition process. As discussed above with respect to FIG. 3B and FIG. 4, instead of determining a constrained or limited grammar at each recognition step, a current recognition set may be determined as a function of an initial grammar and any recognition sets previously determined by the speech engine (e.g., speech engine module 503).

As an option, user interface module 506 may present to the user a categorization of the results of the search. For instance, one or more results may have a common characteristic under which the one or more results may be listed. Such a categorization may be useful, for example, for a user to further narrow the results and/or more easily locate a desired result. For example, the user may be able to select a categorization with which a desired result may be associated.

One example of such a categorization includes a directory assistance application where a user receives, based on an initial search, a number of results from the search. Rather than (or in addition to) receiving the list, the user may be presented a list of categories, and then permitted to select from the list (e.g., in a further voice signal) to further narrow the field of possible results. The categorizations determined from the initial (or subsequent step) results may be used to define a limited grammar used to recognize a voice input used to select the categorization.

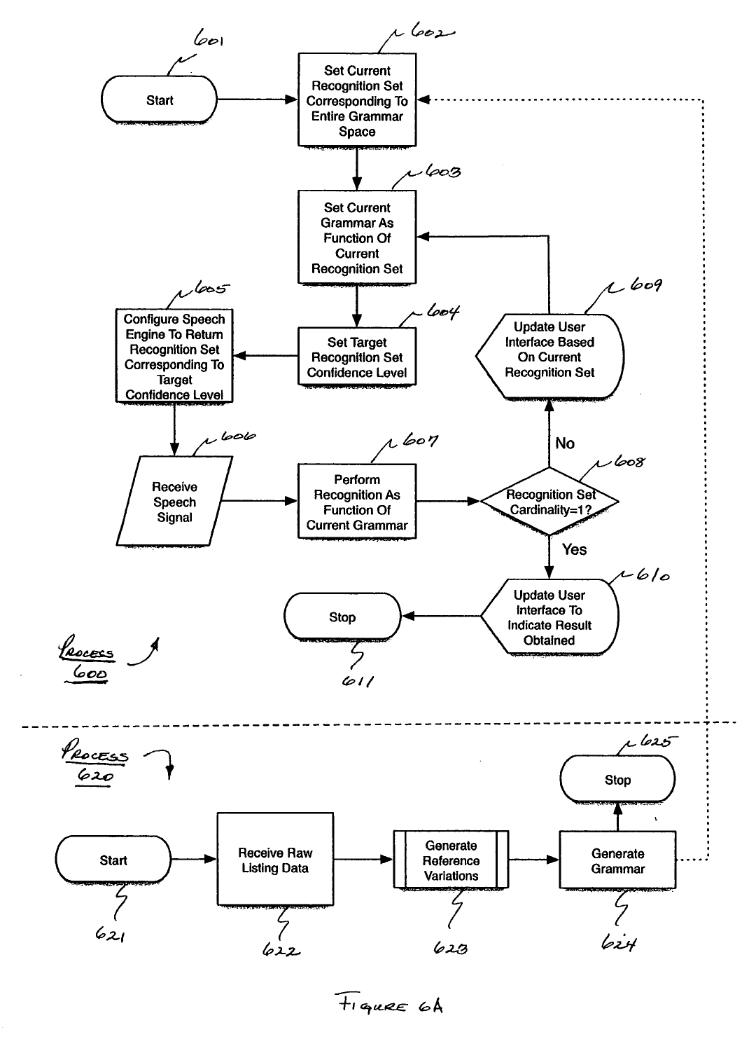

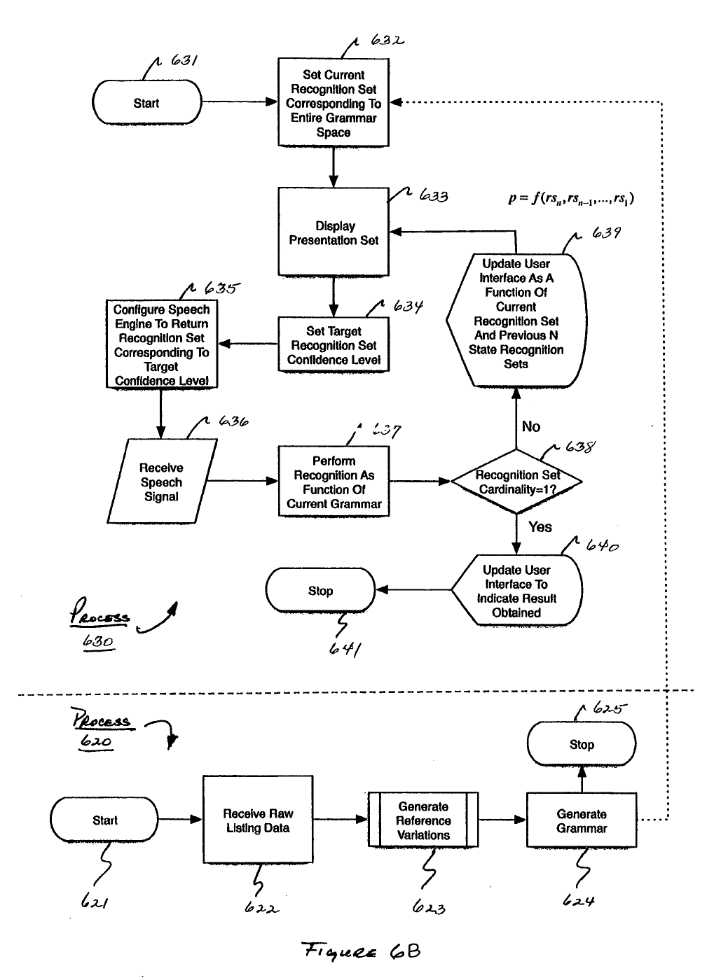

FIG. 6A shows an example process for performing speech recognition according to one embodiment consistent with principles of the invention. For example, one or more components of system 500 may be used to perform one or more acts associated with the speech recognition process shown in FIG. 6A. The process may include, for instance, two processes 600 and 620.

Process 620 may be used to generate a grammar (e.g., an initial grammar 301) to which utterances may be recognized by a speech engine (e.g., speech engine module 503). At block 621, process 620 begins. At block 622, a grammar generator receives a listing of raw data. Such data may include, for instance, data entries from a listing database to be searched by user 201. This listing database may include, for instance, a directory assistance listing database, music database, or any other type of database that may benefit by a speech-enabled search function. For instance, at block 624, a grammar may be generated based on the raw data received at block 622.

As an option, the grammar generator may generate reference variations based on the raw data received at block 622. Such reference variations may be generated in accordance with U.S. patent application Ser. No. 11/002,829, entitled “METHOD AND SYSTEM OF GENERATING REFERENCE VARIATIONS FOR DIRECTORY ASSISTANCE DATA,” filed Dec. 1, 2004, herein incorporated by reference. Other methods for generating reference variations can be used, and principles of the invention are not limited to any particular implementation.

As discussed above, a grammar may be generated. An initial grammar may be created, for example, with all of the possible words and phrases a user can say to the speech engine. In a minimum implementation, the grammar may include a large list of single words to be searched, the words originating from the raw data. In addition, the grammar may be improved by including reference variations such as those determined at block 623. At block 625, process 620 ends.

As discussed above with respect to FIG. 5, an initial grammar (e.g., initial grammar 301) may be used to perform a speech recognition function (e.g., by speech engine module 503). As shown in FIG. 6A, a process 600 may be used to perform speech recognition according to one embodiment consistent with principles of the invention. As discussed above with reference to FIG. 3A, an iterative speech recognition process may be performed that includes a determination of a restricted grammar based on a current recognition set. At block 601, process 600 begins.

At block 602, a current recognition set is used that corresponds to an initial grammar that represents the entire search space of entities to be searched. In one example, the grammar may be produced using process 620, although it should be appreciated that the grammar may be generated by a different process having more, less, and/or different steps.

At block 603, a current grammar is determined as a function of the current recognition set. As discussed above with respect to FIG. 3A, a constrained grammar may be determined based on results obtained as part of the current recognition set. A presentation set may also be determined and displayed to the user based upon the current recognition set. The presentation set may include all or a part of the elements included in the current recognition set.

At block 604, a target recognition set confidence level is set, and at block 605, the speech engine is configured to return a recognition set corresponding to a target confidence level. For instance, an n-best list may be determined based on a recognition confidence score determined by a speech recognition engine, and the n-best list may be presented to the user. In one particular example, the n-best list may be determined by inspecting a confidence score returned from the speech recognizer, and displaying any results over a certain threshold (e.g., a predetermined target confidence level value), and/or results that are clustered together near the top of the results.

At block 606, the system receives an input speech signal from the user. At block 607, the system performs a recognition as a function of the current grammar. As discussed above with respect to FIG. 3A, the grammar may be a modified grammar based on a previous recognition set.

At block 608, it is determined whether the cardinality of the recognition set is equal to one. That is, it is determined whether the result set includes a singular result. If not, the presentation set displayed to the user by the user interface (e.g., user interface 513) is updated as a function of the current recognition set (rsₙ) at block 609, and displayed to the user at block 603. In this way, the interface reflects a narrowing of the result set, and the narrowed result set may serve as a further cue to the user to provide further speech inputs that will narrow the results.

If at block 608, there is a singular result determined (e.g., cardinality is equal to one (1)), the user interface is updated to indicate to the user the identified result at block 610. At block 611, process 600 ends.

FIG. 6B shows another example process for performing speech recognition according to one embodiment consistent with principles of the invention. For example, one or more components of system 500 may be used to perform one or more acts associated with the speech recognition process shown in FIG. 6B. The process may include, for instance, two processes 630 and 620.

Process 620 may be used to generate a grammar (e.g., an initial grammar) to which utterances may be recognized by a speech engine (e.g., speech engine module 503) similar to process 620 discussed above with reference to FIG. 6A.

As discussed above with respect to FIG. 5, an initial grammar may be used to perform a speech recognition function (e.g., by speech engine module 503). As shown in FIG. 6B, a process 630 may be used to perform a speech recognition according to one embodiment consistent with principles of the invention. As discussed above with reference to FIG. 3B, rather than provide a constrained grammar at each level of the search based on results obtained from a previous recognition step as discussed in FIG. 6B, the system may store a state of the recognition at each step of the process and the system may use initial grammar 301 to perform recognitions at each step. At block 631, process 630 begins.

At block 632, a current recognition set is used that corresponds to an initial grammar that represents the entire search space of entities to be searched. In one example, the grammar may be produced using process 620, although it should be appreciated that the grammar may be generated by a different process having more, less, and/or different steps.

At block 633, a presentation set is displayed to the user based upon the current recognition set. The presentation set may include all or a part of the elements included in the current recognition set (rsₙ). At block 634, a target recognition set confidence level is set, and at block 635, the speech engine is configured to return a recognition set corresponding to a target confidence level.

At block 636, the system receives an input speech signal from the user. At block 637, the system performs a recognition as a function of the current grammar. As discussed above with respect to FIG. 3B, the grammar may be the initial grammar (e.g., initial grammar 301) used at each level of the speech recognition process, and the results may be stored for any previous recognition steps and retrieved to determine an output of results.

At block 638, it determined whether the cardinality of the recognition set is equal to one. That is, it is determined whether the result set includes a singular result. If not, the presentation set displayed to the user by the user interface (e.g., user interface 513) is updated as a function of the current recognition set (rsₙ) and any previous recognition set (rsₙ₋₁, . . . , rsₙ₁) at block 639, and displayed to the user at block 633. In this way, the interface reflects a narrowing of the result set, and the narrowed result set may serve as a further cue to the user to provide further speech inputs that will narrow the results.

If at block 638, there is a singular result determined (e.g., cardinality is equal to one (1)), the user interface is updated to indicate to the user the identified result at block 640. At block 641, process 630 ends.

Example Implementation

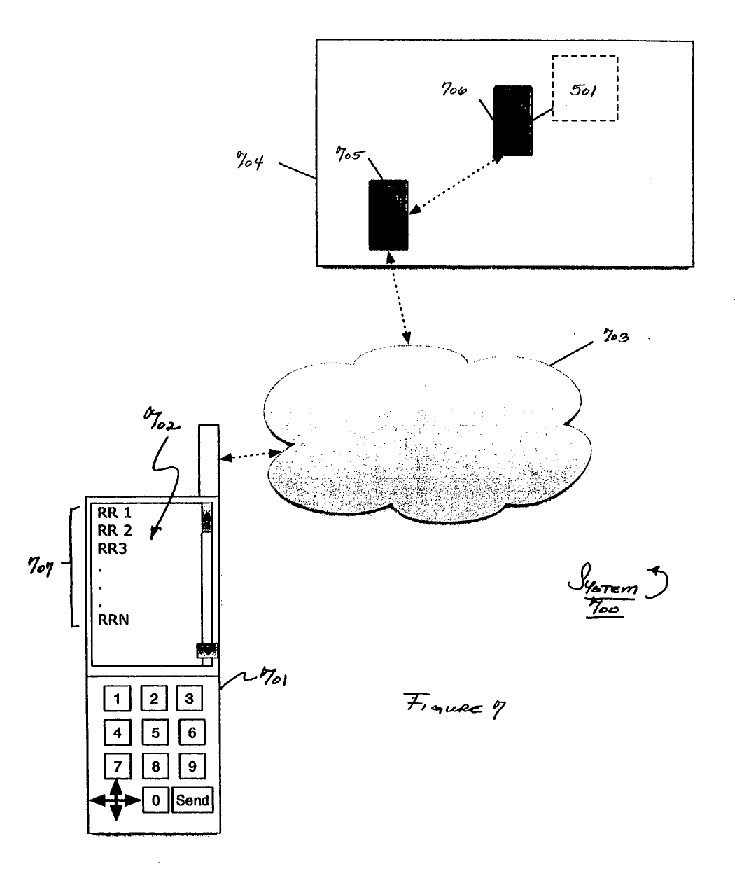

FIG. 7 shows an example system implementation (system 700) according to one embodiment consistent with principles of the invention. In the example shown, a user (e.g., user 201) operating a cellular phone provides a speech signal through a voice network 703 to a system in order to obtain information relating to one or more database entries (e.g., directory service listings).

The “user” in one example is a person using a cellular phone, speaking to a called directory service number (e.g., 411). The user may speak into a microphone of cellular phone 701 (e.g., with microphone within the cellular phone, an “earbud” associated with phone, etc.). Cellular phone 701 may also include a display 702 (e.g., an LCD display, TFT display, etc.) capable of presenting to the user a listing of one or more results 707.

Results 707 may be determined, for example, by a system 704. System 704 may be, for example, a computer system or collection of systems that is/are capable of performing one or more search transactions with a user over a cellular or other type of network. System 704 may include, for example, one or more systems (e.g., system 705) that communicate call information (e.g., speech inputs, search outputs, etc.) between the cell phone and a speech processing system. According to one embodiment, system 706 implements a speech processing system 501 as discussed above with reference to FIG. 5.

In one usage example, the user attempts to find an Indian restaurant, but cannot remember the exact name of the restaurant. The user says “Indian.” The system 704 includes a system 706 having a speech engine (e.g., speech engine module 503) that receives the input speech signal, and determines one or more elements of the input signal. These elements may include one or more words recognized by the input signal, which are then used to perform a search of database.

Results of the search may be presented to the user within interface 707. In one example, the results are presented as a list of items (e.g., RR1 . . . . RRN). One or more elements of the complete listing may by used to represent the complete listing in the list of items (e.g., a name associated with a directory listing).

Alternatively or in addition, the user may be presented one or more categories associated with the search results. Such categorization may be determined dynamically based on the search results, or may be a categorization associated with the entry. Such categorization information may also be stored in a database that stores the entities to be searched. In the example, the user says “Indian,” and the output includes entries that were determined by the speech engine to sound similar. For example, interface 707 displays the following possible choices that sound similar:
Sue's Indian Restaurant
Amber India Cuisine
Shiva's Indian Restaurant
Passage to India
Dastoor and Indian Tradition
Andy and Sons Lock and Key
Indie Records

In response, the user sees the displayed entry for “Shiva's” and recalls that particular restaurant to be his/her restaurant of choice. In a second input, the user says “Shiva's,” and the input is provided to the speech engine. In response, the system may perform another search on the database using the additional information. The results may be ordered based on relevance to the search terms (e.g., by a confidence determination). In the example, the output after inputting the utterance “Shiva's” may cause the system to provide the following output:
Shiva's Indian Restaurant
Sue's Indian Restaurant
Andy and Son's Lock and Key

Because, in this example, the top result is now the one the user wants, the user may select the choice. The top result may be selected, for example, by providing an utterance associated with the entry. For instance, the system may have a predefined word or phrase that instructs the system to select the top result. Other methods for selecting results (e.g., a button or key selection, other voice input, etc.) may be used.

In response to the selection, full details for the selected entry may be displayed, and the user may be permitted to connect to the selection. The output may display to the user after the selection:
Shiva's Indian Restaurant
1234 Main Street
555-1234
Map/Directions/Menu/Hours

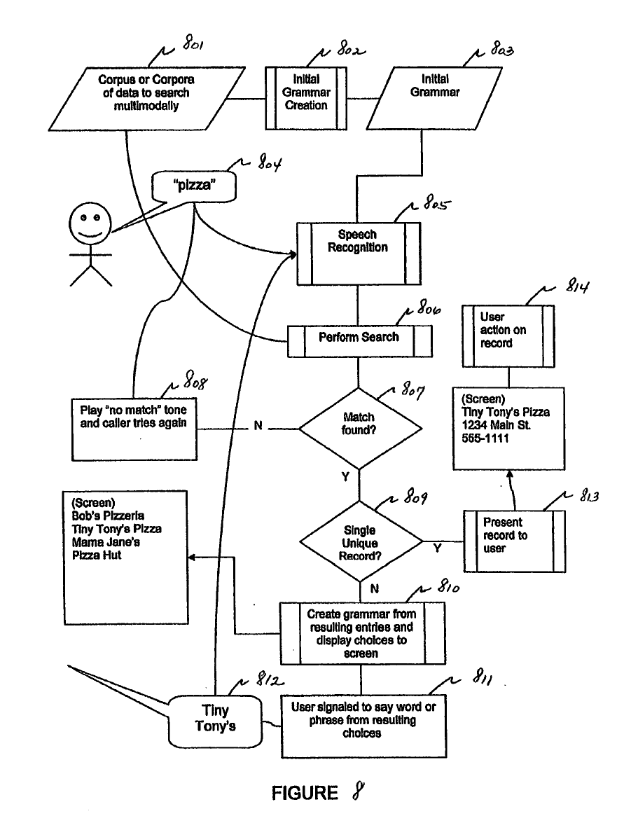

FIG. 8 shows an example implementation of a system according to one embodiment consistent with principles of the invention. At block 801, a corpus (or corpora) of data is provided to search, according to one embodiment, using a multimodal system (e.g., a cell phone, PC, car interface, etc.). The corpus (or corpora) generally includes text strings or text strings along with metadata. Examples of such corpora may include:
Business listings with metadata such as business type, address, phone #, etc. “Passage to India” with metadata indicating that it's an Indian restaurant at 1234 Main Street in Anytown, Calif.
A song, with metadata indicating album, artist, musical genre, lyrics, etc.

At block 802, a process (either at the system, at the service provider, or combination thereof) converts the records in the corpora into an initial search grammar. According to one embodiment, a basic implementation of the process includes taking all the words from each text string from each record and creating a grammar with single word entries. Thus, in one example, records like “John Albert Doe” produces corresponding grammar entries of “John” “Albert” and “Doe.” The grammar can be weighted using many techniques, such as, for example, weighting the more common words that appear in the corpus with higher weightings, and optionally attributing lower weightings to or even eliminating words that are deemed less interesting (e.g. articles like “the”).

More complicated forms of the grammar generation process may include multiple words (e.g. bi-grams, or tri-grams), so the above grammar may contain “John” “Albert” “Doe” “John Albert” “Albert Doe” and “John Albert Doe.” Other variations to the grammar generation process may include using metadata to add to the grammar. For example, if metadata associated with an entry indicates that John Albert Doe is a doctor, words like “doctor” or “MD” might be added to the grammar. Other types of synonym strings can be generated and added to the initial grammar as discussed above to improve recognition and search performance.

At block 803, an initial grammar results from the process(es) performed at block 802. As discussed, a grammar may be expressed in any format, such as GSL. At block 804, the user is prompted to say a word or phrase. For example, the user may say something like “pizza” or “bob's” if searching businesses, or “jazz” or “miles davis” if searching music.

At block 805, the users's spoken utterance is matched against the initial grammar by a speech recognition engine. The speech recognition engine is configured to return multiple results (e.g., an n-best list) of possible recognitions.

At block 806, a search routine compares the results of the speech recognition engine to the corpus or corpora to find matches. In one embodiment, an initial grammar creation process (e.g., at block 802) may have generated synonyms from the records. In this case, the synonyms recognized by the speech engine are matched to those records in the corpora that generated the recognized synonym.

In one example, the search may present, as a list of results, the top result determined from the speech recognizer and any potentially results from the n-best list. According to one embodiment, a determination of which results to present from the n-best list may involve inspecting a confidence score returned from the speech recognizer, and including any results over a certain threshold, and/or results that are clustered together near the top of the results. The acceptance of additional results may stop when there is a noticeable gap in confidence scores (values) between entries (e.g., accepting entities having confidence score values of 76, 74, 71, but stopping acceptance without taking entities having confidence score values of 59, 57, and on down due to a large gap between the 71 and 59 confidence scores). Thus, certain results may be filtered based on confidence score values.

At block 807, it may be determined if one or more matches are returned. If no results are found, optionally, the user may be presented an indication (e.g., by playing a tone and/or visually indicating that no match was found) at block 808. Thereafter, the system may accept another speech input at block 804.

At block 807, if it is determined that one or more matches are found, it is determined at block 809 whether or not a single unique record was returned. If multiple results exist, a further disambiguation may need to be performed. For instance, there can be multiple results from the original n-best list, and/or multiple entries because there are multiple records for a given recognized phrase, and/or other features of the records returned that need further disambiguation, such as if a song has multiple versions or if a business has multiple locations.

If it is determined at block 809 that there is not a single unique match that requires no further disambiguation, a grammar may be created from the resulting entries and displayed to a user at block 810. In one example, the system may take all the resulting matches and may create a grammar based on the results in a manner discussed above with reference to block 802. In one specific example, a grammar may be created using single words out of all the words in all the results returned. More complex examples include using any of the techniques described above with reference to block 802. Optionally, results may be visually presented to a user via a display.

As another option (e.g., at block 811), the system may play a tone or provide some other output type to indicate to the user that more input is needed. At block 812, the user optionally looks at the screen and speaks an additional word or phrase to narrow the resulting choices. Generally, the user may say a word or words from one of the results (e.g., businesses, songs, etc.) presented to the user on the screen. Thus, the user is prompted by the system to provide a further utterance while being presented with cues, rather than rely on the user to provide a perfect utterance or series of utterances. At block 805, the user utterance is sent to the speech recognizer which compares the result to a grammar created for the disambiguation (in one example, using a dynamically created grammar for the recognition instead of the initial grammar).

At block 813, a selected record is presented to the user. This may occur, for example, when all disambiguation steps are complete and a single unique record is isolated from the initial data set. This record may be then presented to the user visually and/or via an audio output. The record may contain the main result text along with any metadata, depending on the type of record being searched. Any or all of this data may be presented to the user. Optionally, the user can take action (or action is automatically taken) taken on the record at block 814. For example, a phone number may be called by the system in the case of a person or business search, or music may be played in the case of a song search.

Other example system types are within the spirit and scope of the invention, and the example above should not be considered limiting. For instance, other search applications may be used by way of example and not by limitation:
Music (song listings, artists, lyrics, purchase)
Movie (listings, theaters, showtimes, trivia, quotes)
Theatre (listings, theatres, showtimes)
Business (databases, directories)
Person (in an address book, via white pages)
Stocks or mutual funds (ticker symbols, statistic, price or any other criteria)
Airports (flight information, arrivals, departures)
Searching e-mail or voicemail (based on content, originator, phone number)
Directory Assistance (business names or people names)
Address Books (personalized business/people names)
Purchases (ringtones, mobile software)
Any other large corpus difficult to recognize
   Grammar Creation and Refinement

As discussed above, various aspects consistent with principles of the invention relate to creating a grammar for use in performing a speech recognition as part of searching process. According to one embodiment, an initial grammar may be created, for example, with all the possible words and phrases a user can say to obtain the first round of results. In one minimum implementation, the grammar can be a large list of single words from the data to be searched (e.g. listing names of businesses, song and album titles for music, etc.). The grammar may be enhanced, for example, by using larger phrases (e.g. all two-word or three-word combinations or even full listing names), by using technology to generate reference variants as discussed above, or by including words from additional metadata for the items (e.g., a cuisine type for a restaurant, such as “pizza” if the listing is “Maldanado's” (does not have “pizza” associated with the listing, but is known to be a pizza place).

One single large grammar can be made for all possible searches (e.g. music, businesses, people, etc.), or individual grammars can be made and the user can be prompted for a category first. The user is prompted to say a word or phrase to begin the search, and an input voice signal is sent to a recognition engine (which attempts recognition against the large initial grammar). The recognition engine may, according to one embodiment, return an n-best list of possible results. The number of results can be tuned using speech settings such as a confidence interval and/or use techniques for locating gaps in the confidence interval returns and returning all results above a certain gap. According to one embodiment, a tuned list of possibilities can be then displayed on the user's screen.

As discussed above, a refined grammar may be made from all the items returned from the initial recognition. Generally, the results may be made viewable on the user's screen, though due to screen size constraints, some may not be visible without scrolling. In one particular example, the refining grammar can be a list of single words from the return (e.g. “Amber,” “Indian,” and “Restaurant” if “Amber Indian Restaurant” is one of the results). Grammar quality can be improved by using larger phrases in the same manner as the large initial grammar as discussed above.

If the top selected result is the result that the user wants, a keyword can be said (or a button pressed on the visual device) to select the top result. If at any point, a recognition confidence is high enough and the result is a unique item, the user (e.g., a caller) may not be required to verbally or physically select the top result; that result may be automatically provided by the system. If the top selected result is not the desired selection, the user may say another word or phrase to further refine the results, thereby further limiting the grammar and the screen presentation until the caller is able to select the desired item.

Result Clustering

According to one embodiment, results can be dynamically “clustered” or categorized to minimize screen usage and enhancing readability, particularly for environments where screen sizes tend to be small. Examples include:
When searching business listings, if one of the options returned has multiple locations in the same town (e.g. “Starbucks”), then the location disambiguation can be performed on a later step (so the screen would only show “Starbucks” and the other possible listing matches, and if “Starbucks” is selected by the user, then an additional screen is presented with all address options).
When searching business listings, if a user says a common word like “bar,” and in one particular example, dozens of establishments are returned, the system may be adapted to identify common words or metatags and first disambiguate among those. Metadata for each result may include a business type like “bar/tavern” or “sushi bar,” and thus the user may be permitted to select between those two selections first rather than the original dozens of results.
When searching for music, if a user says an artist name and hundreds of results are returned, the caller may first be permitted to disambiguate among albums rather than directly to the songs.
According to one example, only salient words needed to disambiguate between results. For example, a caller says “Indian” and is prompted with “Amber” or “Sue's” rather than “Amber India Restaurant” or “Sue's Indian Cuisine.”
Performing disambiguation of classes, like “sushi” or “tavern,” if the caller says “bar” and businesses of multiple types are returned.
Information may be categorized or clustered by location, in the case of business names or people. In one example, the output to the user can include a map instead of only text or voice cue.
Information may be categorized or clustered based on sponsorship (e.g., sponsored businesses for “pizza” may be presented first).
Information may be categorized or clustered based on popularity (e.g., top 10 ringtones downloaded, etc.)

Thus, according to one aspect consistent with principles of the invention, a system is provided that permits seamless category search (e.g., using the categories “pizza” or “flowers”), allowing the user to more easily locate a desired result.

The following examples illustrate certain aspects consistent with principles of the invention. It should be appreciated that although these examples are provided to illustrate certain aspects consistent with principles of the invention, the invention is not limited to the examples shown. Further, it should be appreciated that one or more aspects may be implemented independent from any other aspect. This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of the principles of the invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

As discussed above, various aspects consistent with principles of the invention relate to methods for performing speech recognition. It should be appreciated that these aspects may be practiced alone or in combination with other aspects, and that the invention is not limited to the examples provided herein. According to one embodiment, various aspects consistent with principles of the invention may be implemented on one or more general purpose computer systems, examples of which are described herein, and may be implemented as computer programs stored in a computer-readable medium that are executed by, for example, a general purpose computer.

1. A method for performing speech recognition comprising acts of:
a) setting a current grammar as a function of a first recognition set;
b) upon receiving an utterance from a user, performing a speech recognition process as a function of the current grammar to determine a second recognition set; and
c) generating a user interface as a function of the second recognition set, wherein the act of generating includes an act of presenting, to the user, information regarding the second recognition set.

2. The method according to claim 1, further comprising an act d) repeating acts a) through c) until the recognition set has a cardinality value of 1.

3. The method according to claim 1, wherein the act of setting a current grammar as a function of a first recognition set comprises an act of constraining the current grammar to only include the elements in the second recognition set.

4. The method according to claim 1, wherein the user interface displays, in at least one of a graphical format and a textual format, the elements of the second recognition set.

5. The method according to claim 1, further including an act of generating an initial grammar, the initial grammar corresponding to a totality of possible search results.

6. The method according to claim 5, wherein the initial grammar is generated by determining reference variations for entities to be subjected to search.

7. The method according to claim 5, further comprising an act of using the initial grammar as the current grammar.

8. The method according to claim 1, wherein elements of the second recognition set are determined as a function of a confidence parameter.

9. The method according to claim 1, further comprising an act of accepting a control input from the user, the control input determining the current grammar to be used to perform the speech recognition process.

10. The method according to claim 8, further comprising an act of presenting, in the user interface, a plurality of results, the plurality of results being ordered by respective confidence values associated with elements of the second recognition set.

11. The method according to claim 8, wherein the confidence parameter is determined using at least one heuristic and indicates a confidence that a recognition result corresponds to the utterance.

12. A method for performing interactive speech recognition, the method comprising the acts of:
a) receiving an input utterance from a user;
b) performing a recognition of the input utterance and generating a current recognition set;
c) presenting the current recognition set to the user; and
d) determining, based on the current recognition set, a restricted grammar to be used in a subsequent recognition of a further utterance.

13. The method according to claim 12, wherein the acts a), b), c), and d) are performed iteratively until a single result is found.

14. The method according to claim 12, wherein the act d) of determining a restricted grammar includes an act of determining the grammar using a plurality of elements of the current recognition set.

15. The method according to claim 12, wherein the act c) further comprises an act of presenting, in a user interface displayed to the user, the current recognition set.

16. The method according to claim 15, further comprising an act of permitting a selection by the user among elements of current recognition set.

17. The method according to claim 12, wherein the act c) further comprises an act of determining a categorization of at least one of the current recognition set, and presenting the categorization to the user.

18. The method according to claim 17, wherein the categorization is selectable by the user, and wherein the method includes an act of accepting a selection of the category by the user.

19. The method according to claim 12, wherein the act of determining a restricted grammar further comprises an act of weighting the restricted grammar using at least one result of a previously-performed speech recognition.

20. The method according to claim 12, wherein the act a) of receiving an input utterance from the user further comprises an act of receiving a single-word utterance.

21. A method for performing interactive speech recognition, the method comprising the acts of:
a) receiving an input utterance from a user;
b) performing a recognition of the input utterance and generating a current recognition set; and
c) displaying a presentation set to the user, the presentation set being determined as a function of the current recognition set and at least one previously-determined recognition set.

22. The method according to claim 21, wherein the acts a), b), and c) are performed iteratively until a single result is found.

23. The method according to claim 21, wherein the act c) further comprises an act of displaying, in a user interface displayed to the user, the current recognition set.

24. The method according to claim 23, further comprising an act of permitting a selection by the user among elements of the current recognition set.

25. The method according to claim 21, wherein the act c) further comprises an act of determining a categorization of at least one of the current recognition set, and presenting the categorization to the user.

26. The method according to claim 25, wherein the categorization is selectable by the user, and wherein the method includes an act of accepting a selection of the category by the user.

27. The method according to claim 21, wherein the act c) further comprises an act of determining the presentation set as an intersection of the current recognition set and the at least one previously-determined recognition set.

28. The method according to claim 21, wherein the act a) of receiving an input utterance from the user further comprises an act of receiving a single-word utterance.

29. A system for performing speech recognition, comprising:
a grammar determined based on representations of entities subject to a search;
a speech recognition engine that is adapted to accept an utterance by a user to determine state information indicating a current result of a search; and
an interface adapted to present to the user the determined state information.

30. The system according to claim 29, wherein the speech recognition engine is adapted to determine one or more reference variations, and wherein the interface is adapted to indicate to the user information associated with the one or more reference variations.

31. The system according to claim 29, wherein the speech recognition engine is adapted to perform at least two recognition steps, wherein results associated with one of the at least two recognition steps is based at least in part on state information determined at the other recognition step.

32. The system according to claim 29, wherein the speech recognition engine is adapted to store the state information for one or more previous recognition steps.

33. The system according to claim 32, wherein the state information includes a current recognition set and one or more previously-determined recognition sets, and wherein the interface is adapted to determine a presentation set as a function of the recognition set and at least one previously-determined recognition set.

34. The system according to claim 29, wherein the speech recognition engine is adapted to perform a further utterance by the user using a grammar based on the state information indicating the current result of the search.

35. The system according to claim 34, further comprising a module adapted to determine the grammar based on the state information indicating the current result of the search.

36. The system according to claim 35, wherein the state information includes one or more reference variations determined from the utterance.

37. The system according to claim 36, wherein the interface is adapted to present to the user the one or more reference variations determined from the utterance.

38. The system according to claim 29, wherein the grammar is an initial grammar determined based on a totality of search results that may be obtained by searching the representations of entities.

39. The system according to claim 38, wherein the initial grammar includes reference variations for one or more of the entities.

40. The system according to claim 29, wherein the speech recognition engine is adapted to determine a respective confidence parameter associated with each of a plurality of possible results, and wherein the interface is adapted to present to the user a presentation set of results based on the determined confidence parameter.

41. The system according to claim 40, wherein the interface is adapted to display to the user the plurality of possible results based on the respective confidence parameter.

42. The system according to claim 41, wherein the interface is adapted to display the plurality of possible results to the user in an order determined based on the respective confidence parameter.

43. The system according to claim 41, wherein the interface is adapted to filter the plurality of possible results based on the respective confidence parameter and wherein the interface is adapted to present the filtered results to the user.
